(19) United States
(12) Patent Application Publication
(10) Pub. No.: US 2010/0073306 A1
(43) Pub. Date: Mar. 25, 2010

(54) Dual-view touchscreen display system and method of operation

(75) Inventor: Dallas Dwight Hickerson, Sharpsburg, GA (US)

Correspondence Address: PANASONIC AUTOMOTIVE SYSTEM;COMPANY OF AMERICA, 776 HWY 74 SOUTH, PEACHTREE CITY, GA, 30269, US

(73) Assignee: Panasonic Automotive Systems Company of America, Division of Panasonic Corporation of North America, Peachtree City, GA (US)

(21) Appl. No.: 12/284,760

(22) Filed: Sep. 25, 2008

(51) Int. Cl. G06F 3/041

(52) U.S. Cl. 345/173

(57) ABSTRACT

A dual-view display system (102) includes a dual-view touchscreen display (104) adapted to display a first image including a first menu to a first user positioned at a first location with respect to system (102) and to display a second image including a second menu to a second user positioned at a second location with respect to system (102). The dual-view display system (102) further includes at least one sensor (106, 108) adapted to detect proximity to the dual-view touchscreen display (104) of the first user relative to the proximity to the dual-view touchscreen display (104) of the second user. Menu selection logic (402) identifies a received user touch command as a selection from the first menu or as a selection from the second menu based on the proximity to the dual-view touchscreen display (104) of the first user relative to the proximity to the dual-view touchscreen display (104) of the second user.

### FIELD OF THE INVENTION

The present invention generally relates to electronic display systems. In particular, the present invention relates to a dual-view touchscreen display system and method of operation.

### BACKGROUND OF THE INVENTION

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Some currently available display systems are capable of simultaneously displaying different information depending on the direction from which the screen is being viewed. For example, an automotive implementation of such a display system may provide a map view via a first application to the driver while simultaneously providing a video output such as a DVD movie to the passenger via a second application. If both applications require touchscreen input, a potential problem is identifying which viewer is touching the screen to make a menu selection at a given time. Without a method of identifying which user is activating a touchscreen menu option, the display system has no way of directing the proper application (map or movie) to respond to a touchscreen command. This problem is particularly acute if the touchscreen menu options on the display have the same physical location for both applications.

### SUMMARY OF THE INVENTION

There is provided a dual-view display system. An exemplary dual-view display system comprises a dual-view touchscreen display that is adapted to display a first image including a first menu to a first user who is positioned at a first location with respect to the dual-view display system and to display a second image including a second menu to a second user who is positioned at a second location with respect to the dual-view display system. The dual-view display system further comprises at least one sensor that is adapted to detect proximity to the dual-view touchscreen display of the first user relative to proximity to the dual-view touchscreen display of the second user and a menu selection logic that is adapted to identify a received menu command as a selection from the first menu or a selection from the second menu based on the proximity to the dual-view touchscreen display of the first user relative to the proximity to the dual-view touchscreen display of the second user.

### BRIEF DESCRIPTION OF THE DRAWINGS

The above-mentioned and other features and advantages of the present invention, and the manner of attaining them, will become apparent and be better understood by reference to the following description of one embodiment of the invention in conjunction with the accompanying drawings, wherein:

FIG. 1 is a front view of a dual-view touchscreen display system in accordance with an exemplary embodiment of the present invention;

FIG. 2 is a top view of a dual-view touchscreen display system in accordance with an exemplary embodiment of the present invention;

FIG. 3 is a schematic diagram of a proximity sensing circuit in accordance with an exemplary embodiment of the present invention;

FIG. 4 is a functional block diagram of a dual-view touchscreen display system in accordance with an exemplary embodiment of the present invention;

FIG. 5 is a process flow diagram showing a method in accordance with an exemplary embodiment of the present invention; and

FIG. 6 is a process flow diagram showing a method of identifying an application to which a menu input command is directed in accordance with an exemplary embodiment of the present invention.

Corresponding reference characters indicate corresponding parts throughout the several views. The exemplifications set out herein illustrate a preferred embodiment of the invention, in one form, and such exemplifications are not to be construed as limiting in any manner the scope of the invention.

### DETAILED DESCRIPTION OF THE PREFERRED EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

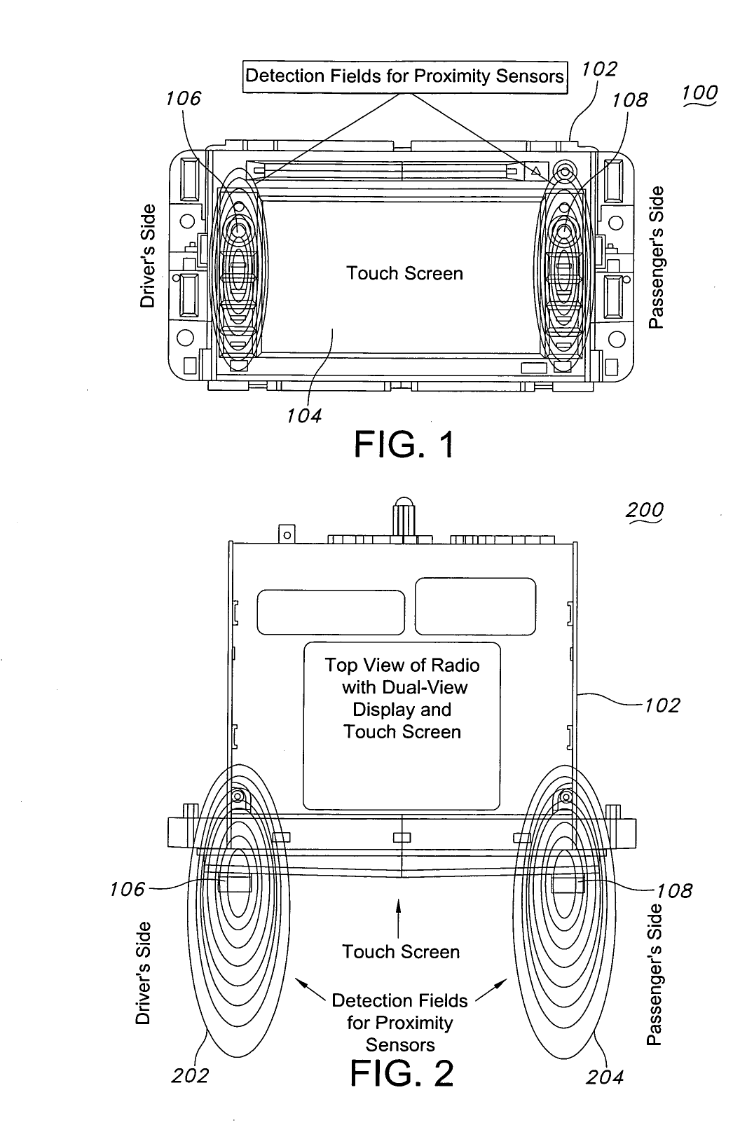

FIG. 1 is a front view of a dual-view touchscreen display system in accordance with an exemplary embodiment of the present invention. The front view is generally referred to by the reference number 100. A dual-view touchscreen display system 102 is adapted to present multiple views depending on the direction from which the screen is being viewed. In an automotive application, the dual-view touchscreen display system 102 may be positioned such that a first user (the driver) sees a display provided by a first application such as a map application. The dual-view touchscreen display system 102 may present a second display from a second application to a second user (the passenger). In one example, the passenger may view a movie from a DVD application at the same time the driver is viewing the map application.

The dual-view touchscreen display system 102 includes a touchscreen 104. The touchscreen 104 allows either user to provide input in the form of menu selections depending upon where a user touches the screen. For example, the map application may from time to time display menu options relevant to the current map display being viewed by the driver on the touchscreen 104. The driver may provide input by touching the touchscreen 104 at a location that corresponds to the desired menu command. In addition, the DVD application may present menu options relevant to the current display being viewed by the passenger on the touchscreen 104. The passenger may provide input by touching the touchscreen 104 at a location that corresponds to the desired menu command.

An exemplary embodiment of the present invention is adapted to distinguish responses or user inputs by touching to the first application from responses or user inputs by touching to the second application even if the physical location of the menu selection areas for the first application physically overlap menu selection areas for the second application. In so doing, exemplary embodiments of the present invention prevent a second viewer of a dual-view display system from mistakenly entering a menu command that would affect the display being viewed by a first viewer of the system. To accomplish this, the dual-view touchscreen display system 102 includes a first proximity sensor 106 and a second proximity sensor 108. As fully set forth below, the first proximity sensor 106 and the second proximity sensor 108 are adapted to detect proximity to the dual-view touchscreen display of the first user and the proximity to the dual-view touchscreen display of the second user, and to use that proximity information to identify the application to which entry of a given menu command is intended or directed.

FIG. 2 is a top view of the dual-view touchscreen display system 102 in accordance with an exemplary embodiment of the present invention. As shown in FIG. 2, the first proximity sensor 106 provides a first proximity detection field 202. Similarly, the second proximity sensor 108 provides a second proximity detection field 204. When the first user reaches for the touchscreen 104 to make a menu selection, the hand of the first user passes through the first proximity detection field 202. As set forth below, the first proximity sensor is adapted to generate a signal indicating that the hand of the first user is proximate to the touchscreen 104 when the hand of the first user encounters the first proximity detection field 202. Similarly, the second proximity sensor 108 is adapted to generate a signal indicating that the second user is proximate to the touchscreen 104 when the hand of the second user passes through the second proximity detection field 204.

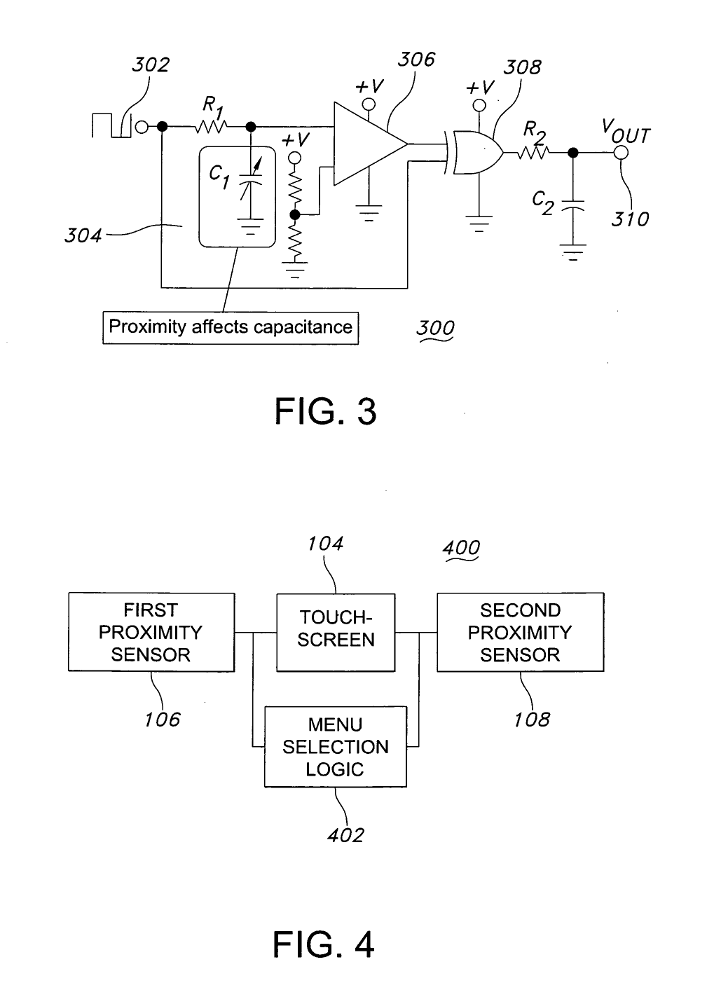

FIG. 3 is a schematic diagram of a proximity sensing circuit in accordance with an exemplary embodiment of the present invention. The proximity sensing circuit is generally referred to by the reference number 300. In an exemplary embodiment of the present invention, replications of the proximity sensing circuit 300 are used as the first proximity sensor 106 and the second proximity sensor 108. The proximity sensing circuit 300 is adapted to receive an input signal 302, such as the output of an oscillator or square-wave generator (not shown). The exemplary proximity sensing circuit 300 includes a variable capacitor 304, the capacitance of which changes in value when a user is proximate thereto. The variable capacitor 304 is connected as one input to a comparator 306. A reference voltage is provided as the other input to the comparator 306.

In the exemplary proximity sensing circuit 300, the input signal 302 and the output of the differential amplifier 306 are delivered as inputs to a Exclusive OR gate 308. The Exclusive OR gate 308 provides an output voltage signal 310 indicative of whether the user is proximate to the variable capacitor 304. Moreover, the magnitude of the output voltage signal 310 varies depending at least in part upon whether the user's hand is present in a proximity detection field of the proximity sensing circuit 300.

Those of ordinary skill in the art will appreciate that, while a capacitive proximity sensor is illustrated in FIG. 3, that the use of other types of proximity sensors are within the scope of the present invention. By way of example, proximity sensors that operate based on inductance, infrared signals, optical signals or the like may be used. The choice of a particular sensor type may be made by one of ordinary skill in the art based on system design considerations.

FIG. 4 is a functional block diagram of a dual-view touchscreen display system in accordance with an exemplary embodiment of the present invention. The block diagram is generally referred to by the reference number 400. The dual-view touchscreen display system 400 includes functional blocks for the first proximity sensor 106 and the second proximity sensor 108. Each of first proximity sensor 106 and second proximity sensor 108 includes a corresponding and respective one of exemplary proximity sensing circuit 300. The dual-view touchscreen display system 400 further includes a functional block for touchscreen 104. Each of 106 and 108 include a 300. In addition, the dual-view touchscreen display system, 400 includes a menu selection logic block 402 adapted to receive input from the proximity sensor 106 and the second proximity sensor 108. Based on this input, the menu selection logic 402 determines whether a selection of a menu command or touch input to the touchscreen 104 is intended to apply to a first application or menu associated with a first view or user or to a second application or menu associated with the second view or user. Those of ordinary skill in the art will appreciate that the menu selection logic block 402 may comprise hardware elements (including circuitry), software elements (including computer code stored on a machine readable medium) or a combination of both hardware and software elements.

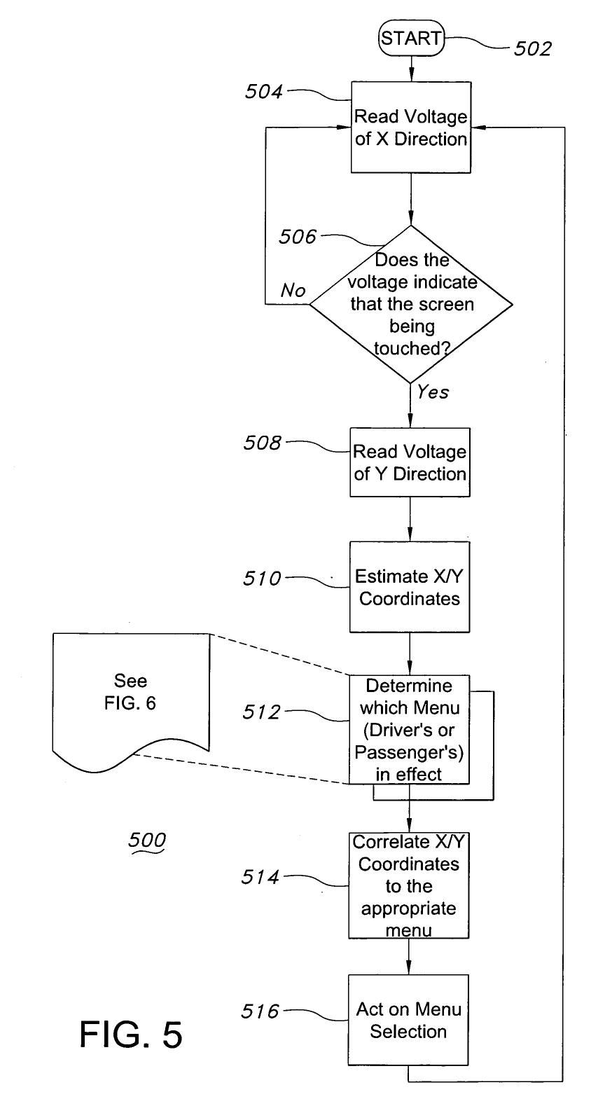

FIG. 5 is a process flow diagram showing a method in accordance with an exemplary embodiment of the present invention. The method is generally referred to by the reference number 500. At block 502, the method begins. At block 504, a voltage associated with an X-coordinate direction (i.e., a horizontal direction in a typical X-Y coordinate system) of the touchscreen 104 is read by the menu selection logic block 402. At decision block 506, a determination is made about whether the voltage read at block 504 indicates that the touchscreen 104 is being touched by a user. If the voltage does not indicate that the touchscreen 104 is being touched, the process flow returns to block 504.

If the voltage indicates that the touchscreen is being touched, a voltage indicative of a position on the touchscreen 104 in the Y-direction is read, as shown at block 508. Those of ordinary skill in the art will appreciate that the menu selection logic block 402 is able to determine a location on the touchscreen 104 based on the voltage readings in the X-direction and the Y-direction. At block 510, the X-Y coordinates corresponding to the location where the touchscreen 104 is being touched are estimated.

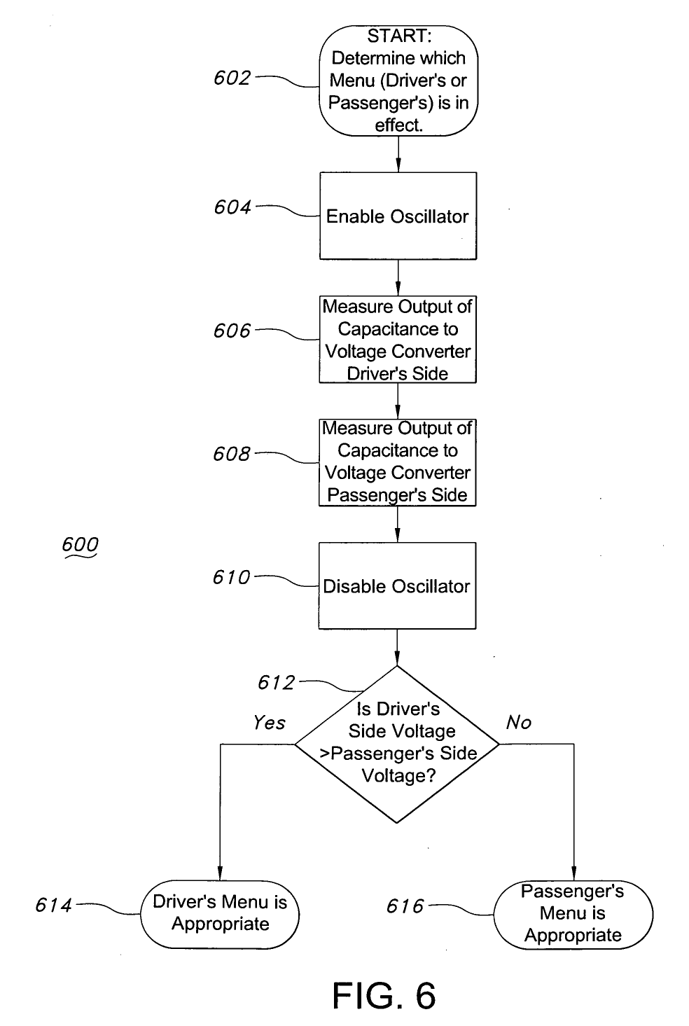

At block 512, the menu selection logic block determines whether the touch input is intended to be a selection or command corresponding to a first menu item of a first menu associated with a first display or a second menu item of a second menu associated with a second display. In other words, the menu selection logic block 402 determines to which of two display applications or menus a touch input command is directed. Additional details with respect to the determination of the correct application or menu to which a menu or touch input command is directed are set forth below with respect to FIG. 6. Moreover, FIG. 6 illustrates a process that employs input data from the first proximity sensor 106 and the second proximity sensor 108 to identify the application to which a given menu command is directed.

At block 514, the menu selection logic block 402 correlates the X-Y coordinates estimated at block 510 to an appropriate menu command. In other words, the menu selection logic block 402 determines what menu command has been entered for the correct application. At block 516, the menu selection logic block 402 acts on the appropriate menu command. Process flow then returns to block 502.

FIG. 6 is a process flow diagram showing a method of identifying an application to which a menu input command is directed in accordance with an exemplary embodiment of the present invention. The process is generally referred to by the reference number 600. The process 600 shows one exemplary embodiment by which a touchscreen command in a dual-view touchscreen display system is determined to be applied to one of two different viewing applications being viewed by two users. Moreover, the process 600 is one exemplary method of determining which menu is being accessed and/or actuated, as shown at block 512 of FIG. 5.

At block 602, the process begins. An oscillator is enabled at block 604. In an exemplary embodiment of the present invention, the oscillator generates the input signals 302 (FIG. 3) for the first proximity sensor 106 (FIG. 1) and the second proximity sensor 108 (FIG. 1). At block 606, the menu selection logic block 402 measures output of the first proximity sensor 106 corresponding to the proximity of the first user. At block 608, the menu selection logic block 402 measures the output of the second proximity sensor 108 corresponding to the proximity of the second user. At block 610, the oscillator is disabled.

At decision block 612, the menu selection logic block 402 determines which user is more likely proximate to touchscreen 104 when a particular touch input or menu command is received. In an exemplary embodiment of the present invention, this determination is made by comparing a voltage measured from the first proximity sensor 106 to a voltage measured from the second proximity sensor 108. If the voltage from the first proximity sensor 106 is greater, the menu selection logic block 402 determines that the received touch input originated or was entered by the first user (e.g., the driver), as shown at block 614. If the voltage measured from the first proximity sensor 106 is not greater than the voltage measured by the second proximity sensor 108, the menu selection logic block 402 determines that the received touch input or menu input originated was entered by the second user (e.g., the passenger), as shown at block 616.

As set forth herein, an exemplary embodiment of the present invention comprises a dual-view touchscreen display system that is able to differentiate between user inputs from a first user viewing the display from a first position and user inputs generated by a second user viewing the display from a second position. Such a system advantageously allows touchscreen menus from various applications to be designed without regard to whether the physical location of touchscreen menu items overlaps with the location of menu items that might be visible in the alternate view.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A dual-view display system (102), comprising:
a dual-view touchscreen display (104) adapted to display a first image including a first menu to a first user positioned at a first location with respect to the dual-view display system (102) and to display a second image including a second menu to a second user positioned at a second location with respect to the dual-view display system (102);
at least one sensor (106, 108) adapted to detect a proximity of at least one of the first user and the second user to the dual-view touchscreen display (104); and
a menu selection logic (402) adapted to identify a received menu command as a selection from the first menu or as a selection from the second menu dependent at least in part upon the proximity detected by said at least one sensor.

2. The dual-view display system (102) recited in claim 1, wherein the at least one sensor (106, 108) comprises a first proximity sensor (106) that provides a first proximity detection field (202) to detect a first proximity, and a second proximity sensor (108) that provides a second proximity detection field (204) to detect a second proximity, and wherein said menu selection logic is adapted to identify a received menu command as a selection from the first menu or as a selection from the second menu dependent at least in part upon said first and second proximities.

3. The dual-view display system (102) recited in claim 1, wherein the at least one sensor (106, 108) comprises a variable capacitor (304).

4. The dual-view display system (102) recited in claim 1, wherein the at least one sensor (106, 108) comprises an inductive sensor.

5. The dual-view display system (102) recited in claim 1, wherein the at least one sensor (106, 108) comprises an infrared sensor.

6. The dual-view display system (102) recited in claim 1, wherein the at least one sensor (106, 108) comprises an optical sensor.

7. The dual-view display system (102) recited in claim 1, wherein the first image comprises a map view.

8. The dual-view display system (102) recited in claim 1, wherein the second image comprises a movie.

9. A method (500) of operating a dual-view display system (102) adapted to display a first image including a first menu to a first user positioned at a first location with respect to the dual-view display system (102) and to display a second image including a second menu to a second user positioned at a second location with respect to the dual-view display system (102), the method comprising:
receiving a menu input command via a touchscreen (104) of the dual-view display system (102);
determining whether the menu input command is directed to the first menu or the second menu dependent at least in part upon the proximity to the dual-view display system (102) of the first user relative to the proximity to the dual-view display system (102) of the second user; and
responding to the menu command dependent at least in part upon said determining step.

10. The method (500) recited in claim 9, wherein the determining step comprises comparing an output of a first proximity sensor (106) to an output of a second proximity sensor (108).

11. The method (500) recited in claim 10, wherein the first proximity sensor (106) and the second proximity sensor (108) each comprises a variable capacitor (304).

12. The method (500) recited in claim 11, wherein the first proximity sensor (106) and the second proximity sensor (108) each comprises an inductive sensor.

13. The method (500) recited in claim 11, wherein the first proximity sensor (106) and the second proximity sensor (108) each comprises an infrared sensor.

14. The method (500) recited in claim 11, wherein the first proximity sensor (106) and the second proximity sensor (108) each comprises an optical sensor.

15. The method (500) recited in claim 9, wherein the first image comprises a map view.

16. The method (500) recited in claim 9, wherein the second image comprises a movie.

17. A dual-view display system (102), comprising:
a dual-view touchscreen display (104) adapted to display a first image including a first menu to a first user positioned at a first location with respect to the dual-view display system (102) and to display a second image including a second menu to a second user positioned at a second location with respect to the dual-view display system (102);
a first proximity sensor (106) providing a first proximity detection field (202), the first proximity sensor (102) providing an indication that the first menu is active when the first user encounters the first proximity detection field (202);
a second proximity sensor (108) providing a second proximity detection field (204), the second proximity sensor (104) providing an indication that the second menu is active when the second user encounters the second proximity detection field (204); and
a menu selection logic (402) adapted to identify a received menu command as a selection from the first menu if the first proximity sensor (106) provides the indication that the first menu is active or to identify the received menu command as a selection from the second menu if the second proximity sensor (108) provides the indication that the second menu is active.

18. The dual-view display system (102) recited in claim 17, wherein the first proximity sensor (106) and the second proximity sensor (108) each comprises a variable capacitor (304).

19. The dual-view display system (102) recited in claim 17, wherein the first proximity sensor (106) and the second proximity sensor (108) each comprises an inductive sensor.

20. The dual-view display system (102) recited in claim 17, wherein the first proximity sensor (106) and the second proximity sensor (108) each comprises an infrared sensor.

21. The dual-view display system (102) recited in claim 17, wherein the first proximity sensor (106) and the second proximity sensor (108) each comprises an optical sensor.

22. The dual-view display system (102) recited in claim 17, wherein the first image comprises a map view.

23. The dual-view display system (102) recited in claim 17, wherein the second image comprises a movie.

24. In a dual-view touchscreen display system (102) adapted to display a first image having a first menu to a first user located at a first position relative to the system (102) and a second image having a second menu to a second user located at a second position relative to the system (I 02), a method of determining the menu to which user touch input to the touchscreen display (104) is directed, said method comprising:
receiving via the touchscreen display (104) a touch input from one of the first and second user;
detecting a proximity of said one of the first and second user to the touchscreen display (104);
determining, dependent at least in part upon said detecting step, whether the touch input is from the first or second user; and
correlating, dependent at least in part upon said determining step, the touch input to an actuated one of the first or second menus.

25. The method of claim 24, comprising the further step of executing, dependent at least in part upon said correlating step, a command of said actuated one of the first and second menus that corresponds to the touch input.
